(19) United States
(12) Patent Application Publication
(10) Pub. No.: US 2007/0267520 A1
(43) Pub. Date: Nov. 22, 2007

(54) METHOD AND APPARATUS FOR SUPPLYING A SPRAYING MACHINE WITH SMALL QUANTITES OF LIQUID PRODUCT TO BE SPRAYED

(76) Inventors: Gianni RAGGI, Imola (IT); Luigi Franzoni, Imola (IT)

Correspondence Address: STITES & HARBISON PLLC, 1199 NORTH FAIRFAX STREET, SUITE 900, ALEXANDRIA, VA, 22314, US

(21) Appl. No.: 11/749,863

(22) Filed: May 17, 2007

(30) Foreign Application Priority Data
May 19, 2006 (IT) BO2006A000384

(51) Int. Cl. B05B 11/04

(52) U.S. Cl. 239/328; 239/327; 239/332; 239/106; 239/418

(57) ABSTRACT

The apparatus for supplying a spraying machine with small quantities of liquid product to be sprayed, in particular for processing small batches of articles (M), presents a spray unit (Z) designed in any way so as to support, removably and preferably in an overturned position, at least one container (C1) made of any suitable rigid or deformable pressure-resistant material, with a small capacity, for example able to contain from one to two litres of paint or other product to be sprayed. The spray unit (Z) is provided with quick-release and/or removable connections (3, 103) and a short pipe (4) for connecting the discharge mouth of said container to the spray guns (Z1) and there being envisaged a pressurization pipe (101, 102) which supplies the pressurized fluid and means are envisaged for pressurizing with this pipe the paint situated inside said container (C1), so that said paint is forced out and is supplied with the desired pressure to said spray guns (Z1).

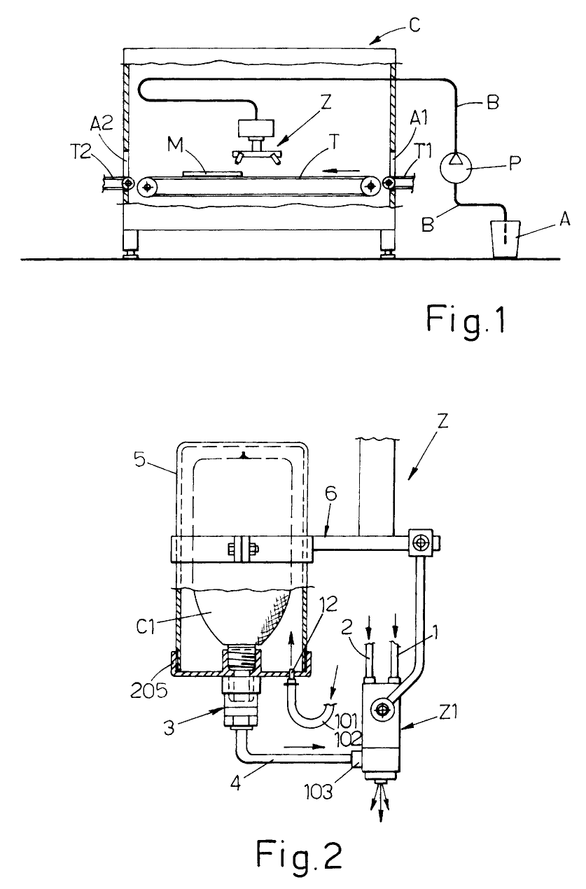

The invention relates to machines for spraying liquid products such as mordants, glues, paints, or other products, onto articles with a mainly flat extension, such as articles made of wood or other material. As shown schematically in FIG. 1 of the accompanying drawings, the machines in question comprise a spray booth C provided with entry and exit gates A1 and A2 for passage of the articles M to be processed, said articles being for example supported inside said booth C by a conveyor T and being sprayed on the visible surface by a unit Z with spray guns, performing a sweeping movement over said articles M. T1 and T2 denote the conveyors for introducing and extracting the articles into/from the booth C, said booth having, operating inside it, means for introducing treated air and suction means for evacuating said air together with the mist which forms during the spraying operation and for filtering this flow in order to capture the polluting agents and ensure that clean air is released into the atmosphere. The action of the air circulating means is such that the booth C remains under a slight vacuum with respect to the external environment such that an air flow has to pass via its gates A1 and A2 on average entering and at a speed on average lying within predetermined values.

In this type of machine or similar machines, for example also in those which extend heightwise and which are able to treat large-size articles, the paint is usually placed inside a container A outside the booth C and is supplied at appropriate pressure values to the spray unit Z via a long circuit B and via a pump P or other suitable pressurization plant. The unit Z has, leading to it, other pipes (not shown in FIG. 1) including a pipe supplying the solvent, a pipe for supplying compressed spraying air and a circuit for controlling regulating valves situated on said unit Z.

When small batches of articles M must be processed with the machine, having to be sprayed with paints or other colour products or products with different characteristics, after each working cycle it is necessary to perform cleaning of the whole length of the pipe B and the pump P, as well as cleaning of the guns, and this operation involves considerable costs owing to the long cleaning time and owing to the large quantity of paint or other material which is lost.

The invention intends to overcome these and other problems of the known art using a method and an apparatus as claimed in the accompanying claim 1 and subsequent dependent claims, based on the following proposed solution. The paint or other product to be sprayed is placed inside a small-capacity container which is mounted on the spray unit Z, which is connected to the guns via a short circuit and which is pressurized via the connection to the compressed air supply circuit or the circuit for supplying the pressurized solvent, all of which so that at the end of each operating cycle, while the guns of the unit Z are disassembled if the latter does not have self-cleaning means, said container with the remainder of the product to be sprayed and with the short pipe for connection to the guns are also disassembled, so as to be able to replace rapidly the whole assembly with a new or clean pipe, with a new or clean container with the new product to be sprayed inside it and with the guns duly cleaned or with new replacement guns. It is evident how this solution involves short cleaning times, with limited wastage of spraying product and how it allows rapid changing of paint or other product in the spraying machines, in particular if there is at least one replacement unit ready to use for the replacement parts.

Further characteristic features of the invention and the advantages arising therefrom will appear more clearly from the following description of some preferred embodiment of the invention, illustrated purely by way of a non-limiting example in the figures of the accompanying drawings in which, in addition to FIG. 1 already considered, it can be seen that:

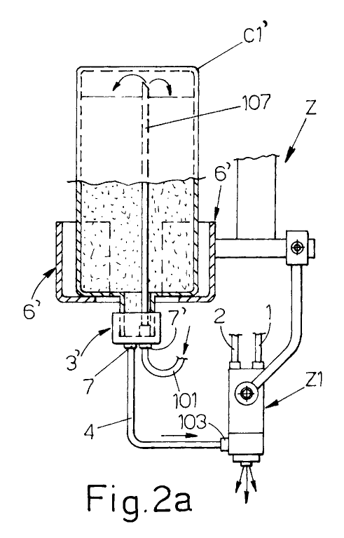

FIG. 2 is a schematic side elevation view of an apparatus according to the invention;

FIG. 2a is a schematic side elevation view of an apparatus according to a constructional variant;

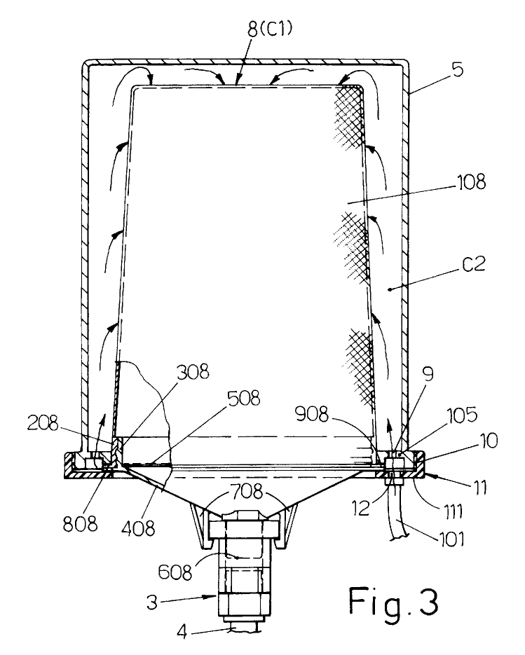

FIG. 3 shows further constructional details of the small container with the product to be sprayed, partly sectioned axially and in the version with pneumatic pressurization as can be seen from FIG. 2;

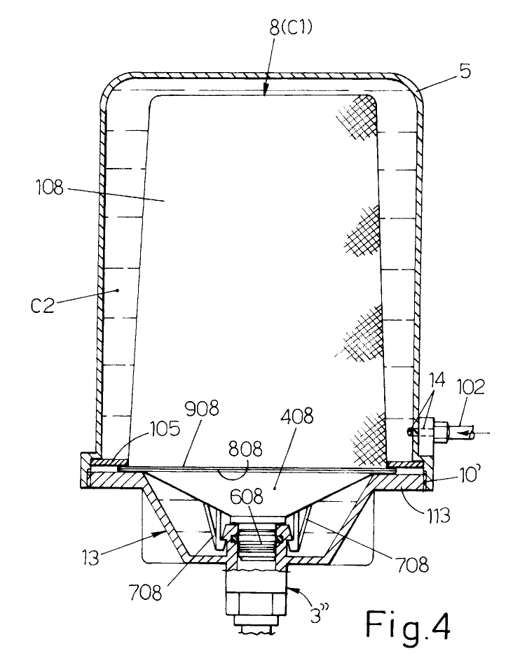

FIG. 4 shows a constructional variant of the small container with the product to be sprayed, partly sectioned axially and in the version with hydraulic pressurization.

In FIGS. 2 and 3, Z denotes the movable spray unit shown here for the sake of convenience with a single gun Z1 which has, leading to it, in the conventional manner not only the tube (not shown) for the air for controlling opening of the guns, but also the pipe 1 for supplying the compressed air and the pipe 2 for supplying the pressurized solvent.

By way of a premise, in the remainder of the description the sole term “paint” will be used for the sake of simplicity to indicate, however, any other type of product which can be sprayed. According to the invention, the paint is placed inside a container C1 or C1′ (see below) made of any suitable rigid or deformable pressure-resistant material, with a small capacity, for example able to contain from one to two litres of paint and designed in any way so as to be able to be mounted preferably overturned on the unit Z according to FIG. 1, where the discharge mouth of the container is connected to the gun Z1 by means of quick-release and/or removable connections 3, 103 and a short pipe 4 and where a pressurization pipe 101 or 102 is envisaged for supplying the pressurized fluid (see below) for pressurizing the paint situated inside the container C, C1′ so that it is forced out and is supplied with the desired pressure to the gun or guns Z1.

According to the solution of FIG. 2, the container C1 may consist of any container for example made of plastic, with a deformable body, the discharge mouth of which is removably connected to the connection 3 and which is housed inside a pressure-resistant container 5 designed to be fastened to the unit Z for example by means of an arm or other removable support means 6. The container C1 is housed inside the container 5 which is then sealingly closed with respect to the exterior by means of a lid 205 provided with an orifice 12 designed for connection to a pressurization pipe 101 or 102 branched off for example to the pipe 1 or to the pipe 2, respectively, which supply the compressed air or the pressurized solvent to the guns Z1 (see below). The cavity C2 present between the container 5 and the internal container C1 is occupied by the pressurized fluid which is supplied from the pipe 101 or 102 and which gradually crushes the container C1 and causes the paint contained in the latter to flow out and be supplied with the desired continuity and pressure to the gun or guns Z1.

In the solution according to FIG. 2a, the paint container C1′ may be made of any soft or also rigid pressure-resistant material and is housed overturned inside a hollow support 6′ fastened to the unit Z. The discharge mouth of the container C1′ is connected to a connector 3′ provided with two orifices 7, 7′, the first of which is open in the region of said connector 3′ and is connected to the discharge pipe 4, while the other orifice 7′ supports a tube 107 which engages inside the overturned container C1′ as far as the upper level of the paint and this orifice is connected to the pressurization pipe 101 which supplies compressed air. With this solution the paint situated inside the container C1′ is pressurized internally by the compressed air and is forced out from the discharge orifice 7 and thus reaches with the desired pressure the spray guns Z1′ via the short pipe 4.

From that shown in FIGS. 2 and 2a it is clear that, at the end of a working cycle, when the paint to be sprayed must be changed, it is sufficient to remove from the unit Z, in addition to the guns Z1 if said unit is not provided with means for self-cleaning of said guns, the container 5 or only the container C1 or C1′ with any residual paint, together with the short pipe 4, so as to be able then to re-assemble on said unit, in addition to any clean guns or new guns, a new container C1 or C1′ with the new paint to be sprayed, and a new or clean container 5, all of which in very short operating times and with a significant reduction in the amount of wasted paint since aforementioned containers have a small capacity and because any residual paint may if necessary be recovered for future use. Using the same procedure it is possible to ensure rapidly the continuity in the supply, to the unit Z, of paints with the same characteristics, should it be necessary to process large batches of articles M.

The invention intends protecting both the solutions mentioned above with reference to FIGS. 2 and 2a, even though the more reliable and versatile solution has proved to be the solution shown in FIG. 2 where the paint may be pressurized at fairly low pressures by means of compressed air or at greater pressures by means of a pressurized liquid, for example using a pressurized solvent, without in the first and second case the pressurization fluid coming into direct contact with the paint. The solution shown in FIG. 2a is characterized by rapid replacement of the various components.

With reference to FIGS. 3 and 4 the practical embodiment of two solutions relating to the basic solution shown in FIG. 2 are now described in greater detail. At present there exists on the market a plastic container 8 produced by 3M® and comprising a body 108 usually with a frustoconical shape and made of soft plastic, with an annular collar 208 made of rigid plastic and designed internally for sealing snap-engagement with the rigid plastic collar 308 of a lid 408 also made of rigid plastic and having internally a filtering baffle 508 with a conical shape and provided in the centre with a mouth 608 and laterally with respect thereto with a pair of fastening lugs 708 which are fixed by means of bayonet engagement to a quick-release connection 3 which may be sealingly connected to said mouth 608. The lid 408 has a laterally projecting flange 808 which is arranged on top of a corresponding flange 908 of the collar 208. This container is at present used to store inside it liquid products, for example paints or other products, and is mounted removably and usually overturned on the dispensing device to which the product is supplied by means of simple gravity and if necessary also by means of suction, while the body 108 of said container gradually collapses onto itself as a result of the external atmospheric pressure and owing to the cavitation caused by the reduction in its internal volume.

FIG. 3 shows how it is possible to use a container 8 of the aforementioned type, housing the body thereof inside a rigid container 5 provided in the region of the mouth with a flange 105 which projects inside it and which has one or more holes 9 connected by means of a chamber to the air supply hole 12 and on which the flange 908 of the collar 208 rests. Said mouth of the rigid container 5 is externally threaded as indicated by 10 so as to be able to screw thereon a ring 11 with an internal flange 111 which is arranged on top of the flange 808 of the lid 408 so as to tighten it firmly and sealingly on the flange 908. The same collar 111 is provided with a hole 12 which is connected to the pipe 101 for supplying compressed air which occupies the internal cavity C2 present between the containers 3 and 8 and which forces the paint out from said container 8 so that it reaches with the desired pressure the delivery gun or guns Z1.

The solution shown in FIG. 4 differs from that shown in FIG. 3 owing to the fact that the mouth of the container 3 is provided with an internal thread 10′ which receives, screwed thereon, the externally threaded collar 113 of a lid 13 which is externally finned in order to facilitate the screwing and unscrewing thereof and which in combination with the flange 105 grips and retains the flanges 808, 908 of the container 8 and which has, integral therewith or mounted in a central position, the quick-release connection 3″ inside which the discharge mouth 608 of said container 8 is sealingly secured. The cavity C2 present between the containers 3 and 8 according to FIG. 4 has, in the region of the lid 13, an orifice 14 which may receive, connected thereto, the pipe 1 02 supplying the pressurized solvent which forces the paint inside the container 8 to supply the dispensing guns Z1 at a pressure greater than that of the solution according to FIG. 3. It must be remembered, however, that the pipes 101 and/or 102 may be controlled by means able to provide a pressure different from that at which the compressed air and/or the solvent are usually supplied to the guns Z1.

1. Method for supplying a spraying machine with small quantities of liquid product to be sprayed, in particular for processing small batches of articles (M), characterized in that the paint or other product to be sprayed is placed inside a small-capacity container (C1, C1′) which is mounted on the spray unit (Z), where this container is connected to the guns via a short circuit and is pressurized internally via the connection to a circuit (101, 102) for supplying a pressurized fluid which forces the paint out so that it reaches the dispensing guns at the desired pressure, all of which being envisaged so that, at the end of each operating cycle, while the guns of the spray unit (Z) are disassembled if the latter does not have self-cleaning means, container (C1, C1′) with the remainder of the sprayed product and with the short pipe (4) for connection to the guns (Z1) are also disassembled, so as to be able to replace rapidly the whole assembly with a new pipe and with a new container with the new product to be sprayed and with the guns duly cleaned.

2. Apparatus for supplying a spraying machine with small quantities of liquid product to be sprayed, in particular for processing small batches of articles (M), in particular for implementing the method according to claim 1, characterized in that the spray unit (Z) of the spraying machine is designed in any way so as to support, removably and preferably in an overturned position, at least one container (C1) made of any suitable rigid or deformable pressure-resistant material, with a small capacity, said spray unit (Z) being provided with quick-release and/or removable connections (3, 103) and a short pipe (4) for connecting the discharge mouth of said container to the spray guns (Z1) and there being envisaged a pressurization pipe (101, 102) which supplies the pressurized fluid and means are envisaged for pressurizing with this pipe the paint situated inside said container (C1), so that said paint is forced out and is supplied with the desired pressure to said spray guns (Z1).

3. Apparatus according to claim 2, in which the paint container (C1) may consist of any container for example made of plastic, with a body which is deformable if intended to be subjected to external pressure and with a rigid discharge mouth and such as to be able to be connected removably and sealingly to a connector (3) which is housed inside a pressure-resistant container (5) designed to be fastened to the spray unit (Z) for example by means of an arm or other removable support means (6), said container (5) being designed so that, after introduction of said container (C1) therein, it may be sealingly closed with respect to the exterior by means of a lid (205) provided with an auxiliary orifice (12) designed for connection to the pressurization pipe (101, 102) which supplies pressurized fluid inside the cavity (C2) present between the external container (5) and the internal container (C1) so that this internal container (C1) is gradually crushed and the paint contained inside it is supplied with the desired continuity and pressure to the spray guns (Z1).

4. Apparatus according to claim 2, in which the paint container (C1′) may be made of any soft or rigid pressure-resistant material and is housed overturned inside a support (6′) fastened to the spray unit (Z) where the discharge mouth of this container (C1′) is connected to a connector (3′) provided with two orifices (7, 7′), the first of which is open in the region of said connector (3′) and is connected to the pipe (4) supplying the guns (Z1), while the other orifice (7′) may support a tube (107) which engages inside the overturned container (C1′) and this orifice is connected to the pressurization pipe (101) which supplies compressed air, so that the paint situated inside the container (C1′) is pressurized internally by the compressed air and is forced out from said discharge nozzle (7) and thus reaches with the desired pressure the spray guns (Z1).

5. Apparatus according to claim 3, in which it is possible to use a known container (8) with a soft body (108), housing this body inside a rigid container (5) provided in the region of its mouth with an internally projecting flange (105) which is provided with one or more holes (9) and on which the flange (908) of the collar (208) of this container (8) rests, it being envisaged that said mouth of the rigid container (5) is externally threaded or otherwise designed to secure there removably a ring (11) with an internal flange (111) which is arranged on top of the flange (808) of the lid (408) of said known container (8), so as to secure it firmly and sealingly on said flange (908), there being envisaged on said flange (111) an orifice (12) which is connected to the pipe (101) supplying the compressed air which occupies the internal cavity (C2) present between said containers (5, 8) and which forces the paint out from the internal container with a deformable body (8) so as to reach with the desired pressure the spray gun or guns (Z1).

6. Apparatus according to claim 3, in which the mouth of the rigid container (5) is provided with an internal thread (10′) which receives, screwed thereon, the externally threaded collar (113) of a lid (13) which in combination with the flange (105) grips and retains the flanges (808, 908) of the known container (8) with a soft body and which has, integral therewith or mounted in a central position, a quick-release connection (3″) to which it is possible to secure sealingly the discharge mouth (608) of said container (8), the cavity (C2) present between said containers (5, 8) being provided in the region of the lid (13) with an orifice (14) which may have, connected thereto, a pipe (1 02) for supplying the pressurized solvent which forces the paint out from the internal container (8) with a deformable body so as to reach with the desired pressure the spray gun or guns (Z1).

7. Apparatus according to claim 1, characterized in that the pressurization pipes (101, 102) may be branched off to the pipes (1, 2) which respectively supply the compressed air or the pressurized solvent to the guns (Z1), this connection being performed directly or via means able to provide these pipes with a pressure different from that with which the compressed air or the solvent are supplied to the spray guns (Z1).
